(19) United States
(12) Patent Application Publication
(10) Pub. No.: US 2017/0238759 A1
(43) Pub. Date: Aug. 24, 2017

(54) ROTATABLE GRILLING DEVICE

(71) Applicant: Archipelago Group LLC, Lakewood, CO (US)

(72) Inventors: Bruce Prior, Lakewood, CO (US); George Prior, Culver City, CA (US); Andrew Hunt Taylor, Memphis, TN (US)

(21) Appl. No.: 15/405,063

(22) Filed: Jan. 12, 2017

Related U.S. Application Data
(60) Provisional application No. 62/278,235, filed on Jan. 13, 2016.

(51) Int. Cl. A47J 37/07; F24B 1/20

(52) U.S. Cl. CPC A47J 37/0704; F24B 1/207

(57) ABSTRACT

A rotatable grilling device that may be used to rotate a grilling surface relative to a heat source of a grilling device. The rotatable grilling device may comprise a support structure for supporting the grilling surface relative to the heating device. The support structure may allow for rotation and the efficient transfer of heat to the grilling surface.

### RELATED APPLICATIONS

This application claims benefit of U.S. Provisional Application 62/278,235 filed on Jan. 1, 2016 entitled “ROTATABLE GRILLING DEVICE”, the entirety of which is incorporated by reference herein.

### BACKGROUND

Grilling food often requires special attention to the intensity and disposition of a heat source of a cooking structure. For example, the intensity and disposition of the charcoal briquettes may influence the temperature across a grilling surface of a charcoal barbecue.

While many barbeque chefs desire to alter the temperature of a grilling surface, it is often hard to find suitable mechanisms to achieve this functionality. Traditional “snap-on” assemblies include a rotating cooking grate positioned above an existing stationary cooking grate (i.e., a “static” grate specifically configured for grilling food within a given cooking structure). In this approach, the duel-grate configuration (i.e., a rotating cooking grate adjacently disposed to a stationary cooking grate) limits and distorts the distribution of heat throughout a cooking structure (e.g., due to the multiple layers of grate material). The excess material contributes to a lack of circulation in the cooking structure and increases the weight of the cooking structure due to the inclusion of excess materials.

This cumbersome, dual-layer approach may also make clean-up exceedingly difficult. The lower static grate may collect grease and dirt during the grilling process (e.g., due in part to the adjacent disposition of the lower static grate with the upper rotating cooking grate), which may contribute to grease fires, flare-ups, and other undesirable outcomes. In this regard, conventional solutions leave the barbeque chef with few options to rotate food relative to a heat source in a manner that avoids the foregoing deficiencies.

### SUMMARY

The present disclosure relates to a rotatable grilling device, for example, for use in rotating a grilling surface relative to a heat source, such as charcoal briquettes and/or other heat sources associated with barbequing or otherwise grilling food.

It has been recognized herein that because temperatures may vary across such grilling surfaces, it may be desirable to rotate the grilling surface relative to the heat source. In this manner, food disposed at a particular location on the grilling surface may be exposed to various temperatures by rotating the grilling surface relative to the heat source. This may be ideal for grilling food in a manner that utilities various cooking temperatures (e.g., a high-heat cooking stage following by a low-heat cooking stage, etc.) to achieve a desired final grilled product.

To meet the needs of the grilling challenges discussed above, the present disclosure presents an elegantly simple, yet robust design that facilitates altering the temperature of a grilling surface by rotating a grilling surface relative to a heat source with a single-layer spinning cooking surface (e.g., grilling grate) that replaces the existing static cooking surface of a conventional charcoal grill. The single-layer spinning cooking surface may be rotatably attached to a support structure to allow for rotation about a common axis (e.g., via an axel and bushing assembly). The common axis may extend perpendicularly to the extent of the cooking surface. The support structure includes a unique spoke assembly configured for maximum heat distribution throughout a cooking structure (e.g., by limiting structural impediments between the charcoal briquettes and the spinning cooking surface). In this regard, the support structure may include a fewer number of supports than that of the cooking surface. In various embodiments, the support structure may include less than six spokes, less than five spokes, less than three spokes. As such, the limited number of spokes extending between the heat source and the cooking surface may promote more even and efficient heat distribution to the cooking surface.

The existing grill grate supports of the charcoal grill (i.e., those supports integral to the cooking structure initially configured to support the existing static grill grate) engage the support structure and rotatably attached spinning cooking surface within the charcoal grill such that the single-layer spinning cooking surface structure and associated support structure replaces the existing grilling grate of the cooking structure, thereby allowing the cooking surface to rotate relative to the heat source.

The absence of excess materials or overlapping grilling surfaces allows food disposed at the spinning cooking surface to experience different temperatures (e.g., by rotating the cooking surface) in manner that contributes to even heat distribution throughout the cooking structure and prevents excess grease build up common to the conventional dual-grate systems. It will be appreciated that the single-layer spinning cooking surface and associated support structure may be configured in a variety of other manners to facilitate the foregoing, including installing the single-layer cooking surface and associated support structure within a charcoal grill in various different configurations that result in the cooking surface being disposed at various heights relative to the heat source.

### BRIEF DESCRIPTION OF THE DRAWINGS

FIG. 1 is an expanded assembly view of an embodiment of a rotatable grilling device in a system for grilling food.

FIG. 2a is a top view of an embodiment of a grilling surface of a rotatable grilling device.

FIG. 2b is a side view of an embodiment of a grilling surface of a rotatable grilling device.

FIG. 3a is a top view of an embodiment of a support structure of a rotatable grilling device.

FIG. 3b is a side view of an embodiment of a support structure of a rotatable grilling device.

FIG. 4 depicts a side view of an embodiment of a rotatable connection between a grilling surface and a support structure of a rotatable grilling device.

FIGS. 5A and 5B depict an embodiment of a rotatable grilling device.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

Disclosed herein are utilities (e.g., apparatuses, systems, processes, etc.) for a rotatable grilling device, for example, for use in rotating a grilling surface relative to a heat source (e.g., charcoal briquettes) of a cooking structure (e.g., a charcoal grill) in a manner that promotes efficient heat transfer to the cooking structure (e.g., by providing a support structure for a rotating grilling surface free of unnecessary structural impediments, such as those that block efficient heat transfer to food disposed for grilling at the grilling surface). In this regard, the disclosed utilities may employ a grilling surface (e.g., a metal grate or any other appropriate structure) configured axial rotation relative to an associated support structure about an axis. The grilling surface may include an axial rotational member receivable by a bushing of the support structure disposed along a common axis. The support structure may include one or more spokes extending from the bushing to an outer support ring. In turn, the outer support ring may be disposed in adjacent relation to one or more support tabs of the cooking structure such that the rotatable grilling surface and associated support structure are positioned above a heat source of the cooking structure.

Reference will now be made to the accompanying drawings, which assist in illustrating the various pertinent features of the various novel aspects of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

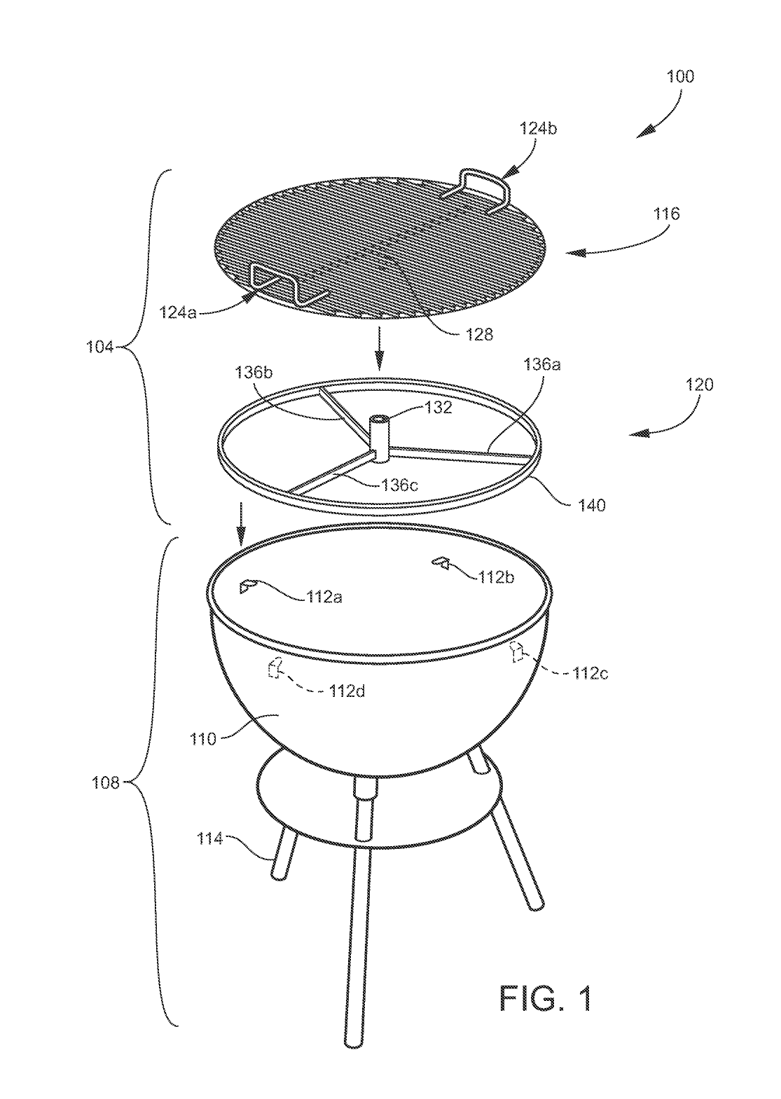

In this regard, FIG. 1 presents an expanded assembly view of a system 100 for grilling food. The system 100 may include a rotatable grilling device 104 for use in rotating food relative to a heat source and a cooking structure 108. In some implementations, the cooking structure 108 may be a hemispherical bowl 110 configured to receive charcoal briquettes (not shown). The hemispherical bowl 110 may include one or more support tabs 112 (e.g., L-shaped brackets, etc.), arranged in any appropriate configuration to provide structural support in relation to a grilling grate disposed thereon. In the illustrated embodiment of FIG. 1, the hemispherical bowl 110 includes four such support tabs 112 (112a, 112b, 112c, 112d) arranged circumferentially about the hemispherical bowl 110. The cooking structure may be freestanding, and include one or more support legs 114 configured to support the weight of the cooking structure and any associated implements and mechanisms of the present invention. In other implementations, the cooking structure 108 may include other configurations appropriate to house a heat source for use in grilling food and support a rotatable grilling surface.

The rotatable grilling device 104 includes a grilling surface 116 and a support structure 120. Grilling surface 116 and support structure 120 may be of any appropriate shape and configuration corresponding to the geometry (and associated support tabs 112) of hemispherical bowl 110 (e.g., such that the rotatable grilling device 104 may be supportively engaged by the cooking structure 108). In one embodiment, the grilling surface 116 and support structure 120 are substantially circular in shape. The grilling surface 116 may comprise a metal grate (wire mesh, etc.) or other thermally conductive material designed for contactable relation with food for purposes of grilling. The grilling surface 116 may include a first handle 124a and a second handle 124b configured to facilitate the rotation of the grilling surface 116 with respect to the support structure 120. The grilling surface 116 may further include axial member 128. The axial member 128 may be disposed about an axis transverse to the plane of the grilling surface 116 configured for supporting a food item. In some instances, the axial member 128 may be concentric with the grilling surface 116.

The support structure 120 may be configured to receive the grilling surface 116 (via the axial member 128) for rotatable attachment thereat. In this regard, the support structure 120 may include a bushing member 132 configured for receiving the axial member 128 of the grilling surface 116. In this regard, the axial member 128 may rotate relative to and within the bushing member 132. The bushing member 132 may be integrally connected with one or more spokes 136. In the illustrated embodiment of FIG. 1, the bushing 132 is integrally connected with an arrangement of three such spokes 136 (136a, 136b, 136c) that are disposed circumferentially about an exterior surface of the bushing 132. Each of the spokes 136 may therefore extend from an exterior surface of the bushing 132 to an interior surface of an outer support ring 140 at which each of the spokes 136 are integrally connected. In turn, the outer support ring 140 may be disposed adjacent to each of the support tabs 112 of the hemispherical bowl 110. In this regard, the support structure 120 may remain stationary relative to the cooking structure 108 while the grilling surface 116 is rotatable about the bushing 132.

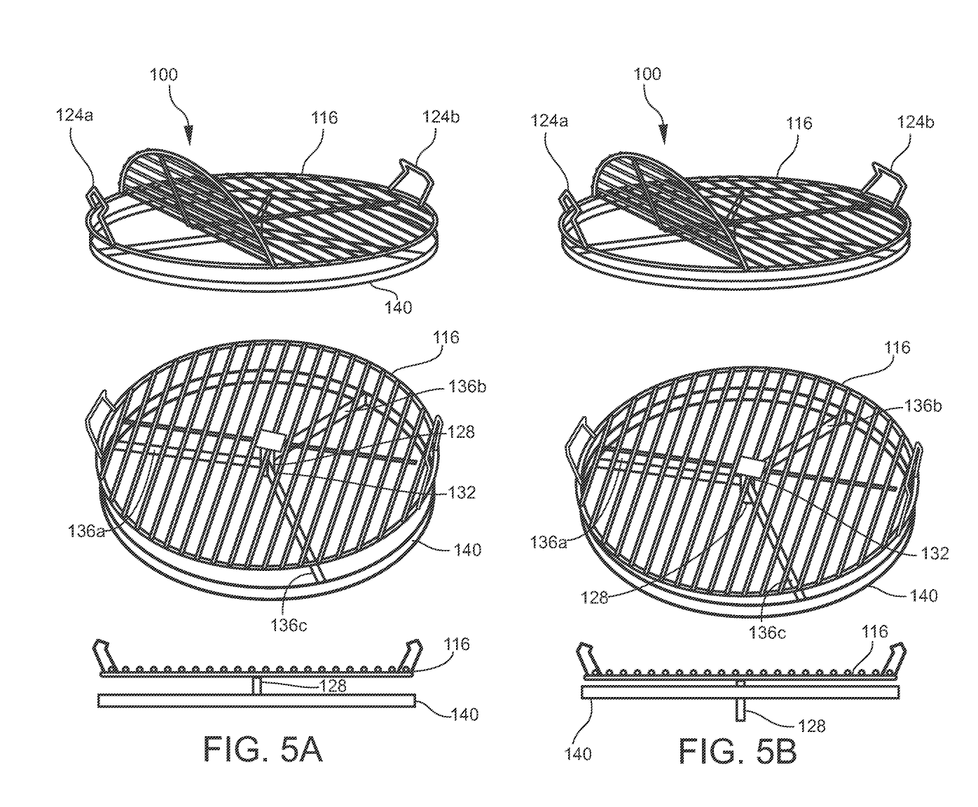

FIGS. 5A and 5B depict another embodiment of a rotatable grilling device 100. The device 100 may be generally as described above. Additionally, the grilling surface 116 may have a section that is pivotal to allow at least a portion of the grilling surface 116 to pivot relative to the remainder of the grilling surface 116. This may allow for access to the hemispherical bowl 110 when the grilling device 100 is in place relative to the cooking structure 108. For instance, a portion of the grilling surface 116 may be pivoted to allow for additional fuel or the like to be added to the hemispherical bowl 110. Furthermore, items in the bowl 110 (e.g., charcoal, wood chips, etc.) may be manipulated via the resulting opening when the grilling surface 116 is pivoted away.

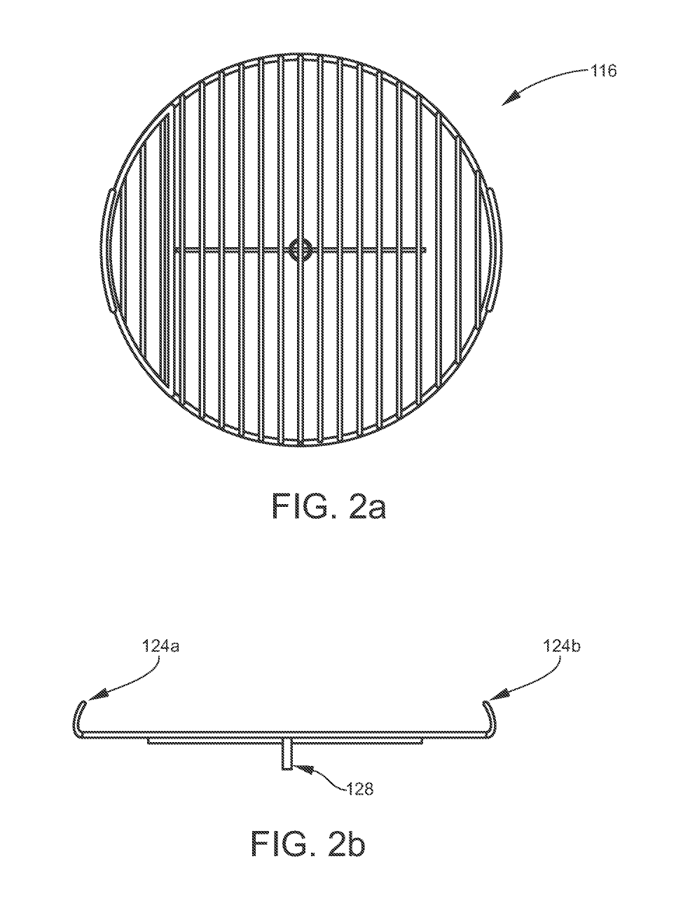

FIGS. 2a and 2b present a top view and a side view of the grilling surface 116, respectively. In this regard, it will be appreciated that the grilling surface 116 may be configured to receive food thereat for purposes of grilling. In particular, the grilling service 116 may include a series of metallic or otherwise conductive grating members that substantially span diameter of the grilling surface 116.

As discussed above, the support structure 120 may have fewer members (e.g., spokes 136) than the grilling surface 116. In turn, efficient heat transfer may be realized to the grilling surface 116 as the members of the support structure 120 may extend between a relatively small overlapping area between the heat source and the grilling surface 116. As such, a large portion (e.g., at least a majority of the area) of the grilling surface 116 may have direct exposure to the heat source (i.e., not have any support structure disposed between the grilling surface 116 and the heat source). For instance, as in the depicted embodiment, the support structure 120 may only have three spokes 136. In other embodiments, the support structure may have fewer than five spokes 136 (i.e., four spokes), fewer than six spokes 136, or fewer than seven spokes 136.

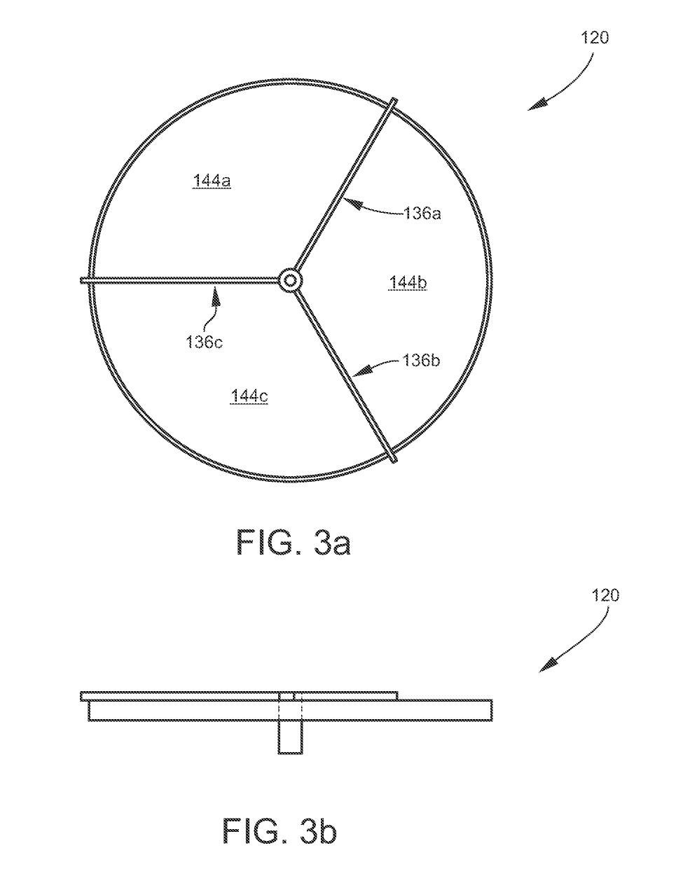

FIGS. 3a-3b present a top view and a side view of the support structure 120, respectively. Because the bushing 132 is integrally joined with the outer support ring 140 via the one or more spokes 136, the support structure 120 may include multiple apertures 144 that facilitate the distribution of heat throughout the cooking structure 108. The illustrated embodiment of FIG. 3A, for example, the support structure 120 may include three such apertures 144 (144a, 144b, 144b). In this regard, the support structure 120 rotatably supports the grilling surface 116 in a manner that substantially limits any structural impediments between the heat source (e.g., charcoal briquettes) and the grilling surface 116 (i.e., heat may freely flow through the aperture). Accordingly, food disposed at the grilling surface 116 may be rotated in relation to the fuel source in a manner that is not hindered by inefficient or unexpected heat distribution patterns, as may be present with multiple overlapping conventional grates.

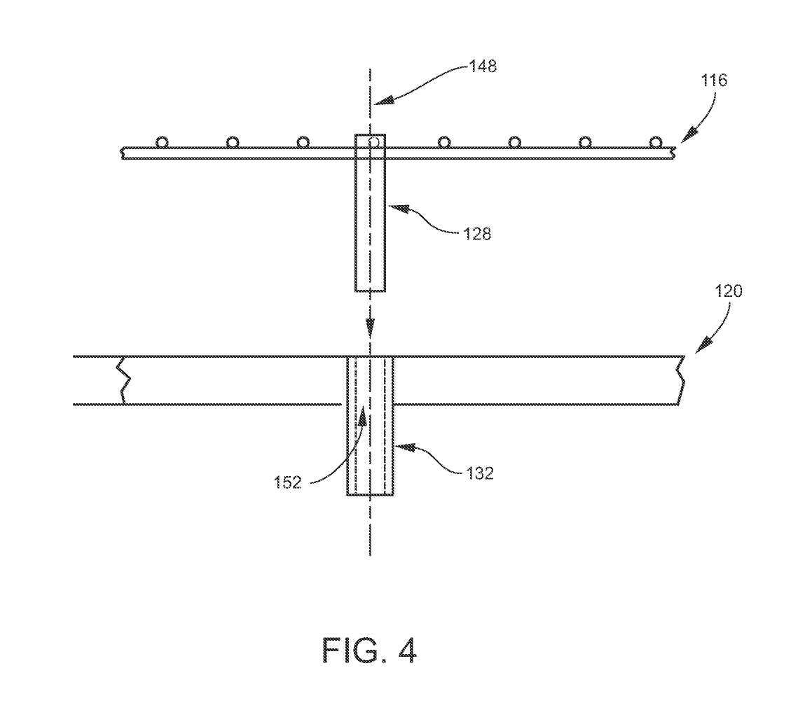

FIG. 4 presents a side view embodiment of a rotatable connection as between the grilling surface 116 and the support structure 120. In particular, the axial member 128 and bushing member 132 may be aligned about a common axis 148. The bushing 132 may include inner chamber 152 configured to receive the axial member 128 about the axis 148. In one of implementation, the inner chamber 152 may be dimensioned in relation to the diameter of the axial member 128 such that the bushing 132 provides structural support for the grilling surface 116 while allowing the grilling surface 116 to rotate about the axis 148.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention.

The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A rotatable grilling device, comprising:
a support structure adapted for supportive engagement by a grilling device and having a plurality of support members;
a grilling surface comprising a thermally conductive material to support a food item;
a bearing assembly engaged with the plurality of the support members support structure and the grilling surface to facilitate rotational engagement of the grilling surface relative to the support structure;
wherein the support members extend between the grilling surface and a heat source of the grilling device when the support structure is supported by the grilling device such that at least a majority of the grilling surface is directly exposed to the heat source.

2. The rotatable grilling device of claim 1, wherein the support structure comprise an annular support ring adapted for engagement of a hemispherical bowl for containing the heat source.

3. The rotatable grilling device of claim 2, wherein the plurality of support members comprise spokes extending from the annular support ring radially toward the bearing assembly.

4. The rotatable grilling device of claim 3, wherein the support structure comprises fewer than five spokes.

5. The rotatable grilling device of claim 3, wherein the support structure comprises three spokes.

6. The rotatable grilling device of claim 1, wherein the grilling surface is rotatable relative to the support structure about an axis perpendicular to a plane in which the grilling surface extends.
